(19) United States
(12) Patent Application Publication
(10) Pub. No.: US 2025/0141143 A1
(43) Pub. Date: May 1, 2025

(54) DEVICE FOR ELECTRICALLY JOINING TWO SECTIONS OF ELECTRICAL CABLE, METHOD FOR CONNECTING TWO SECTIONS OF ELECTRICAL CABLE BY WAY OF SUCH A DEVICE, AND POWER CABLE EQUIPPED WITH SUCH A DEVICE

(71) Applicant: SAFRAN ELECTRICAL & POWER, BLAGNAC (FR)

(72) Inventors: Laurent Pierre François Jules AZEMARD, MOISSY CRAMAYEL (FR); Jérôme GENOULAZ, MOISSY CRAMAYEL (FR)

(21) Appl. No.: 18/717,125

(22) PCT Filed: Nov. 25, 2022
(86) PCT No.: PCT/FR2022/052178

§ 371 Date: Jun. 6, 2024

(30) Foreign Application Priority Data
Dec. 8, 2021 (FR) FR2113111

(51) Int. Cl. H01R 13/405; H01R 13/05; H01R 13/11; H01R 13/17; H01R 13/53; H01R 101/00

(52) U.S. Cl. CPC H01R 13/405; H01R 13/052; H01R 13/111; H01R 13/17; H01R 13/53; H01R 2101/00; H01R 2201/26

(57) ABSTRACT

An electrical joining device for connecting a first section and a second section of an electric cable, includes a first cabling head including an L-shaped first conductive element, mounted on the end of the first cable section, and a first insulating element surrounding the first conductive element; a second cabling head including an L-shaped second conductive element, mounted on the end of the second cable section, and a second insulating element covering the second conductive element, an arm of the second conductive element, covered by the second insulating element, being housed between the first conductive element and the first insulating element so as to permit a rotation between the first cabling head and the second cabling head.

### TECHNICAL FIELD OF THE INVENTION

The present invention relates to an electrical junction device for connecting two sections of electrical cable with a change of direction at the junction of between 0 and 360°. The invention also relates to a method for connecting two sections of electrical cable by means of this electrical junction device. The invention further relates to a power cable provided with two sections connected through this electrical junction device.

The invention finds applications in all fields of electrical power transport, such as the fields of rail, maritime, land, space transport, etc. It finds, in particular, applications in the field of aeronautics for the transport of electrical power within aircraft and especially the power required for the propulsion of hybrid and electric aircraft.

### Technological Background of the Invention

Aeronautical manufacturers are seeking to develop aircraft with electric or hybrid propulsion. These types of electric or hybrid propulsion require the production and transport of high electrical power for generating sufficient thrust for the aircraft to take off, remain in the air and land, whatever the type of aircraft: Vertical Take-Off and Landing (VTOL) aircraft, Short Take-Off and Landing (STOL) aircraft, Conventional Take-Off and Landing (CTOL) aircraft, commercial or military aeroplanes, helicopters or drones.

Generally speaking, high electrical power is obtained by combining high voltages, for example voltages of up to 3000V, and high currents, for example currents of up to 1000 A. The electrical interconnection system on board these electric or hybrid propulsion aircraft, known as the EWIS (electrical wiring interconnection system), has to be capable of transporting high currents and high voltages in order to distribute them between the numerous items of electrical equipment distributed throughout the aircraft, such as generators, batteries, power electronics, electric motors, etc.

On the other hand, transporting high currents requires the use of electrical conductors, generally made of copper or aluminium, with large cross-sectional areas, such as AWG8 to AWG4/0 gauge or more, and high voltages require very thick electrical insulators, the role of which is not only to ensure dielectric strength but also to prevent partial discharges at low pressure, due to the high altitude.

Currently, cables used in aeronautics are cables in which the cross-section of the conductive element (also known simply as the conductor) does not allow necessary currents to be transported to cover all electric or hybrid propulsion applications. Indeed, the maximum cross-sectional area of aeronautical cables to date is 107 mm², which corresponds to AWG4/0 (American Wire Gauge). Because of their large overall size, high mass, large radius of curvature and high stiffness, which make them difficult to install, AWG4/0 cables are almost never used in conventionally propelled aircraft. Indeed, in an aircraft, cables sometimes have to include changes of direction, for example to connect an engine or motor with a cable passing through the wings or to make the cable transit from the wings to the fuselage of the aircraft.

On the other hand, the transport of high currents for electric or hybrid propulsion aircraft may require cables with a cross-sectional area even greater than that of the AWG4/0 gauge. While AWG4/0 cables are already little used because of their difficulty of installation, it seems obvious that the installation of cables even larger than AWG4/0 gauge cables is problematic, especially because of their high stiffness, which requires a very large radius of curvature for installation in an aircraft. This installation problem is also encountered for cables with a gauge smaller than AWG4/0 due to the often restricted space available in wings and other walk zones.

The transport of high currents is therefore an obstacle to the development of hybrid or electric propulsion aircraft.

To facilitate installation of cables with a large radius of curvature and stiffness, it has been contemplated to sever the cables into several sections, depending on the desired cable route, and then to connect these sections to each other by means of a connection device.

There are different connection devices for electrically connecting two cable sections. There is, for example, a junction device integrated into the wiring and generally consisting of a one-piece conductive element and an add-on insulating element. The conductive element generally includes a crimping zone at each end thereof, to which one of the cable sections is crimped. Both cable sections are then connected to each other by this one-piece conductive element. This junction device, commonly known as a “splice”, forms a rigid connection that is permanently mounted to the cable and cannot be dismantled. Although this junction device provides a secure, uninterrupted connection, it has the drawback of being rectilinear and even more rigid than the cable itself. It therefore does not allow any change of direction between two sections of a cable.

Other connection devices include, for example, connectors and terminal block and lug systems, the purpose of which is essentially to connect two cables of the same link together during installation on an aircraft. Connection terminal blocks are generally connected to cables via electrical lugs. However, these electrical lugs are rectilinear and mounted to the terminal block along a same axis. Terminal block and lug systems therefore do not allow change of direction between two sections of a cable.

Connectors generally include two distinct parts, a socket and a plug, each mounted to one of the sections of the cable to be connected. The plug and the socket of a connector can be assembled with fittings adapted to form a 45° or 90° bend. The two cable sections, one connected to the plug and the other to the socket, can thus be joined together in a bent way in two different directions. While connectors can allow change of direction within the cable, they have the drawback of adding a break into the electrical connection. By definition, the plug and socket are disconnectable, yielding electric breakdowns with all the associated problems. For a power cable transporting high current, drawbacks and risks associated with an electric breakdown are particularly high: risk of disconnection in service, risk for the protection of people (e.g. against electric shocks of the electric shock/electrocution type), multiplication of wiring references, potential difficulties of accessibility for connecting and disconnecting the connector, need for tests and checks on aircraft, weight, cost, availability of products, etc.

There is therefore a real need for an electrical junction device allowing relative change of direction between both sections of a cable, without folding said cable.

### SUMMARY OF THE INVENTION

To address the problems discussed above of change of direction of power cables in aircraft, the applicant provides an electrical junction device including two wiring heads orientable relative to each other.

According to a first aspect, the invention relates to an electrical junction device for connecting a first section and a second section of an electrical power cable, comprising a first wiring head and a second wiring head orientable relative to each other:
the first wiring head including:
   a first L-shaped conductive element mounted at the end of the first cable section and including a cylindrical shape arm; and
   a first insulating element surrounding the first conductive element;
the second cable head including:
   a second L-shaped conductive element, mounted at the end of the second cable section and including a hollow cylindrical shape arm; and
   a second insulating element covering the second conductive element, the arm of the second conductive element covered with the second insulating element being housed between the first conductive element and the first insulating element so as to permit rotation between the first wiring head and the second wiring head,

the electrical junction device further comprising a retention clip (110) mounted between the first conductive element (210) and the second conductive element (310) to prohibit any translational displacement of the first wiring head (200) relative to the second wiring head (300).

The permitted rotation between the two wiring heads allows both cable sections to be oriented differently from one another. The electrical junction device is therefore orientable and allows easy change of direction of the cable, in any direction, even when the cable is of a large cross-sectional area (i.e. with an AWG4/0 gauge or even larger or even smaller).

A power cable, or simply cable, is understood to be an electrical cable that allows transport of high electrical power (with high current and voltage). The term “power cable” or “electric cable” or “cable” designates any type of single or multi-strand, flat or round, conductive wire surrounded by a dielectric material. The terms “power cable”, “electrical cable” or “cable” therefore also designate buses, busbars, terminal blocks or any other power equipment.

Further to the characteristics just discussed in the previous paragraph, the electrical junction device according to one aspect of the invention may have one or more additional characteristics from among the following, considered individually or according to any technically possible combinations:
the junction device comprises a retention clip mounted between the first conductive element and the second conductive element to prohibit any translational movement of the first wiring head relative to the second wiring head.
an external surface of the arm of the first conductive element includes a first groove and an internal surface of the arm of the second conductive element includes a second groove, the retention clip being partly mounted in the first groove and partly in the second groove.
the first conductive element and the second conductive element each comprise a hollow forearm adapted to receive, respectively, the first cable section and the second cable section.
the first section of the electrical cable and the second section of the electrical cable are mounted by crimping, respectively, in the first conductive element and in the second conductive element.
the junction device comprises an O-ring seal housed between the first insulating element and the second insulating element.
the junction device comprises an electrical contact ring housed between the arm of the first conductive element and the arm of the second conductive element.
the first and second insulating elements each comprise, on their external surface, an electromagnetic shielding metallisation zone.
the junction device comprises a shielding continuity ring, housed between the first insulating element and the second insulating element.
the first insulating element and the second insulating element each comprise, on their forearm, a knurling zone adapted to receive an electromagnetic shielding braid.
the junction device comprises a locking device ensuring locking of the relative angular position between the first and second cable heads once the first and second cable sections are in position.
the locking device includes a screw passing through the first insulating element and partially housed in the second insulating element.
the second insulating element and/or the first insulating element is overmoulded, respectively, onto the second conductive element and/or the first conductive element.
the arm of the first wiring head and the arm of the second wiring head are positioned along a first axis of rotation, the first wiring head being orientable up to 360° along this axis of rotation with respect to the second wiring head.
it includes an intermediate wiring head, said intermediate wiring head being mounted with the first wiring head along a first axis of rotation and mounted with the second wiring head along a second axis of rotation so that the first wiring head is orientable in a dual orientation with respect to the second wiring head.
the first conductive element and/or the second conductive element includes, at an end opposite to the arm, a planar connection zone for interfacing with flat equipment such as a busbar or a terminal block.

A second aspect of the invention relates to a power cable including at least two cable sections connected through at least one junction device as defined above.

A third aspect of the invention relates to a method for connecting a first power cable section with a second power cable section by means of the electrical junction device as defined above, which includes the following operations:
selecting a previously fabricated junction device;
connecting the first cable section to the first L-shaped conductive element of the first wiring head; and
connecting the second cable section to the second L-shaped conductive element of the second wiring head.

Advantageously, the method includes:
an operation of installing the first and second cable sections connected;
relatively angularly positioning the first wiring head with respect to the second wiring head; and
mounting a locking screw at least partially in the first and second insulating elements in order to lock the relative angular positioning of the first and second wiring heads.

According to one advantageous embodiment, the method includes prior operations of manufacturing the junction device:
overmoulding the first conductive element with a first insulating element so as to form the first wiring head;
overmoulding the second conductive element with a second insulating element so as to form the second wiring head;
installing a retention clip between an arm of a first conductive element and an arm of a second conductive element;
installing an O-ring seal between the first insulating element and the second insulating element;
installing an electrical contact ring between the arm of the first conductive element and the arm of the second conductive element;
fitting the first wiring head into the second wiring head.

Advantageously, the method according to one aspect of the invention may include at least one of the following operations:
making a metallisation zone on an external surface of the first and second insulating elements; and
installing a shielding continuity ring between the first insulating element and the second insulating element.

### BRIEF DESCRIPTION OF THE FIGURES

Further advantages and characteristics of the invention will become apparent upon reading the following description, illustrated by the figures in which:

FIG. 1 represents a schematic exploded perspective view of an example of an electrical junction device according to the invention;

FIG. 2 represents front and profile views of examples of an electrical contact ring mounted in the junction device of FIG. 1;

FIG. 3 represents a schematic view of an example of the manufacture of the first wiring head of the electrical junction device according to the invention;

FIG. 4 represents a schematic view of an example of the manufacture of the second wiring head of the electrical junction device according to the invention;

FIG. 5 represents a schematic perspective view of an example of connection of the first wiring head with the second wiring head of the device of FIG. 1;

FIG. 6 represents several schematic perspective views of the electrical junction device according to the invention in different orientations;

FIG. 7 represents, in the form of a functional diagram, an example of a method for connecting two cable sections with the electrical junction device according to the invention;

FIG. 8 represents alternatives to the device according to the invention wherein one of the ends of said device includes a planar connection zone.

### DETAILED DESCRIPTION

One exemplary embodiment of an orientable electrical junction device, wherein two cable sections can be connected with a change of direction, is described in detail hereinafter, with reference to the appended drawings. This example illustrates the characteristics and advantages of the invention. It is, however, reminded that the invention is not limited to this example.

In the figures, identical elements are marked by identical references. For reasons of legibility of the figures, the size scales between the elements represented are not respected.

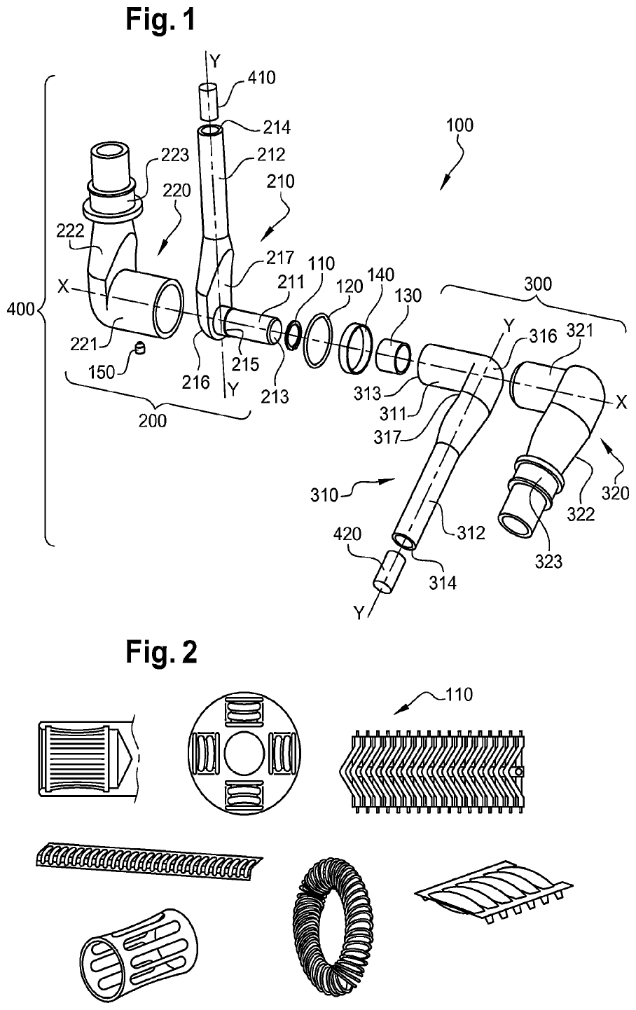

One example of an electrical junction device according to the invention is represented in an exploded view in FIG. 1. This electrical junction device 100 (referred to more simply as a junction device) includes a first wiring head 200 and a second wiring head 300, adapted to fit into each other while being orientable relative to each other.

The first wiring head 200 comprises a first, substantially L-shaped, conductive element 210, with an arm 211 which extends along a first direction X and a forearm 212 which extends along a second direction Y, substantially perpendicular to the direction X. The first conductive element 210 is made of an electrically conductive material such as copper or aluminium. It may be covered with a coating having electrical conduction properties and providing protection against corrosion, wear, seizing, etc. By way of example, this coating may be of the silver, gold or nickel plating type. The first conductive element is dimensioned according to the current level, the current density being between 0.1 and 30 A/mm², and preferably between 1 and 10 A/mm².

The arm 211 and the forearm 212 are mechanically and electrically integral with each other. They can be made in one piece from an electrically conductive material. Alternatively, they can be manufactured separately (in the same electrically conductive material or in different conductive materials) and then attached to each other, for example by welding or soldering, so as to form a single conductive element with electrical continuity between the arm and the forearm. The first conductive element 210 thus includes a bend 216 in a zone where the arm 211 and the forearm 212 integrally join each other.

The arm 211 of this first conductive element 210 is cylindrical in shape. It may be formed by a solid cylinder or a hollow cylinder, closed or not closed at its free end 213. The forearm 212 of the first conductive element 210 is at least partially hollow and adapted to receive one end of a first section 410 of the electrical cable 400 to be connected. In particular, the forearm 212 includes a hollow free end 214 in which the end of the first cable section 410 is housed. The forearm 212 may, for example, be cylindrical, at least in its part close to the end 214, for receiving the first cable section 410. In its part close to the bend 216, the forearm 212 may be solid or hollow and include a planar surface 217 at least around the zone where the arm 211 and the forearm 212 join each other integrally. In this part close to the bend 216, the forearm 212 may, for example, be semi-cylindrical or rectangular or of any other shape as long as this shape allows the arm 211 and the forearm 212 to be integral with each other and to form substantially a right angle.

The first wiring head 200 also comprises a first insulating element 220, at least partially surrounding the first conductive element 210. This first insulating element 220 may be made of any dielectric material such as, for example, PEEK (polyetheretherketone), PEKK (polyetherketoneketone), PFA (perfluoroalkoxy), Polyetherimide or any other thermoplastic, thermoset or polymer material adapted to the environmental and electrical restrictions of the application. The thickness of this first insulating element depends on the atmospheric pressure (related to the flight altitude if the environment is not pressurised), the operating voltage and the material used. It can, for example, be between 0.2 and 5.4 mm, and preferably between 0.4 and 4.25 mm. According to one embodiment, the insulating element 220 is of the PFA type and has a thickness of 1.70 mm, thus enabling it to be used for operating DC voltages of 800V in a non-pressurised environment, for flight altitudes of up to 55,000 feet.

The insulating element 220 may be as a single piece, made in one piece and then mounted around the first conductive element. The insulating element 220 is, for example, overmoulded around said first conductive element 210. Alternatively, the insulating element 220 can be made by assembling several parts, in the materials mentioned previously or others such as machined ceramic. The assembly may be carried out by mechanical fasteners of the screw/nut type, by bonding, welding or any other method.

The first insulating element 220 includes an insulating arm 221, designed to surround the arm 211 of the first conductive element, and extending to a forearm 222 designed to surround the forearm 212 of the first conductive element 210. In the example of FIG. 1, the arm 221 of the first insulating element 220 is cylindrical with a diameter greater than the diameter of the arm 211 of the first conductive element 210 so that there is a clearance between the first conductive element 210 and the first insulating element 220 at their arms 211, 221.

The second wiring head 300 comprises a substantially L-shaped second conductive element 310, with an arm 311 extending along a first direction X and a forearm 312 extending along a second direction Y, substantially perpendicular to the direction X. The second conductive element 310 may be identical to the first conductive element 210 or different but with characteristics identical to those previously described for the first conductive element. The arm 311 and the forearm 312 of the second conductive element 310 are mechanically and electrically integral with each other. They can be made in one piece from an electrically conductive material. Alternatively, they can be manufactured separately, of the same conductive material or of two electrically conductive materials, and then attached to each other, for example by welding or soldering, so as to form a single conductive element (with electrical continuity between the arm and the forearm). The second conductive element 310 thus includes a bend 316 in the zone where the arm 311 and the forearm 312 join each other integrally.

The arm 311 of this second conductive element 310 is cylindrical and hollow. As explained in more detail below, this arm 311 is adapted to be housed around the arm 211 of the first conductive element 210. The internal diameter of the arm 311 of the second conductive element 310 is therefore greater than the external diameter of the arm 211 of the first conductive element 210. The forearm 312 of the second conductive element 310 is at least partially hollow and adapted to receive one end of a second section 420 of the electrical cable 400 to be connected. In particular, the forearm 312 includes a hollow free end 314 in which the end of the second cable section 420 is housed. The forearm 312 may, for example, be cylindrical, at least in its part close to the end 314, intended to receive the second cable section 420. In its part close to the bend 316, the forearm 312 may include a planar surface 317 at least around the zone where the arm 311 and the forearm 312 join each other integrally. In this region close to the bend 316, the forearm 312 may, for example, be semi-cylindrical or rectangular in shape or any other shape allowing the arm 311 and the forearm 312 to be integral with each other and to form a substantially right angle.

The first and second conductive elements 210, 310 may be of the male and female type, respectively, with an electrical contact ring 130 in the form, for example, of a reed or spring strip. Several examples of electrical contact rings 130 are represented in FIG. 2. In one alternative, the first and second conductive elements 210, 310 may be of the planar contact, disc-shaped pressure type with the use of a reed washer as a replacement for the strip.

Further to the second conductive element, the second wiring head 300 also comprises a second insulating element 320 at least partially wrapping the second conductive element 310. This second insulating element 320 may or may not be similar to the first insulating element 220. It may be made of the same materials with the same characteristics as previously described for the first insulating element 220.

The second insulating element 320 includes an insulating arm 321, designed to surround the arm 311 of the second conductive element, and extending to a forearm 322 designed to surround the forearm 312 of the second conductive element 310. In the example of FIG. 1, the second insulating element 320 surrounds the second conductive element 310 along its entire length, i.e. from the free end 313 of the arm 311 to the free end 314 of the forearm 312, so that there is no or almost no clearance between the second conductive element and the second insulating element.

The first wiring head 200 and the second wiring head 300, previously described, are adapted to fit into each other and form electrical continuity between the first cable section 410 and the second cable section 420. To achieve this electrical continuity, the first and second cable sections 410, 420 are irreversibly connected in the first and second conductive elements 210, 310 respectively. This connection can be made, for example, by crimping, i.e. with mechanical deformation of part of the first and second conductive elements. The first cable section 410 is then crimped in the forearm 212 of the first conductive element 210 and the second cable section 420 is crimped in the forearm 312 of the second conductive element 310. According to one alternative, the connection may be made by any other mechanical means capable of ensuring pressure contact between the cable section and the conductive element, or by a method of soldering/welding the cable section and the conductive element.

A protection can be installed around the connection zone between the cable section 410, 420 and the conductive element 210, 310 to provide not only mechanical protection, but also electrical insulation and sealing of this connection zone. This protection can be achieved, for example, after crimping, by overmoulding with a polymer or by adding a heat-shrinkable piece or even by adhering two half-shells placed on either side of the connection zone.

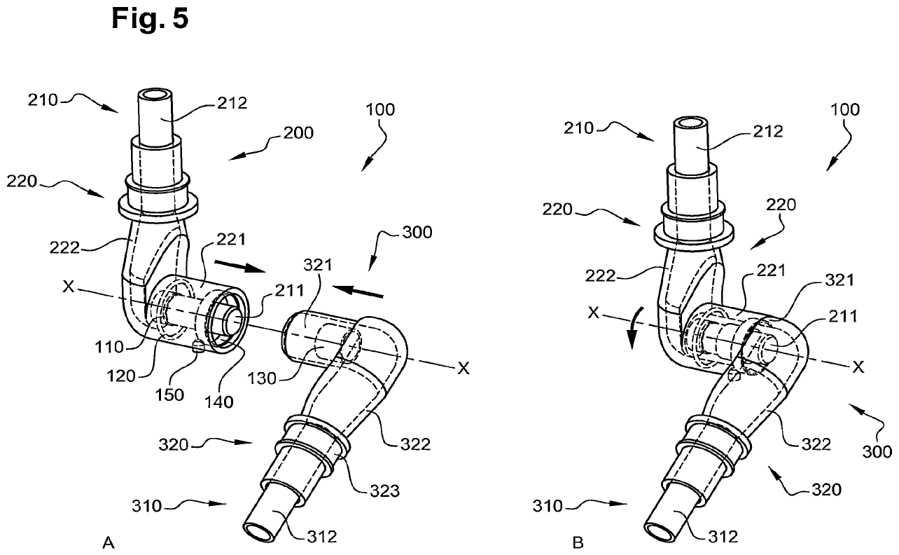

As represented in FIG. 5, the two wiring heads 200 and 300 are assembled with each other so that, on the one hand, the arm 211 of the first conductive element 210 is inserted inside the arm 311 of the second conductive element 310 (i.e. in the hollow part of the arm 311 in the form of a hollow cylinder) and, on the other hand, the arm 311 of the second conductive element 310, covered with the insulating element 320, is inserted in the clearance between the arm 211 of the first conductive element and the arm 221 of the first insulating element 220. This assembly is carried out by inserting the second wiring head 300 into the first wiring head 200 linearly along axis XX.

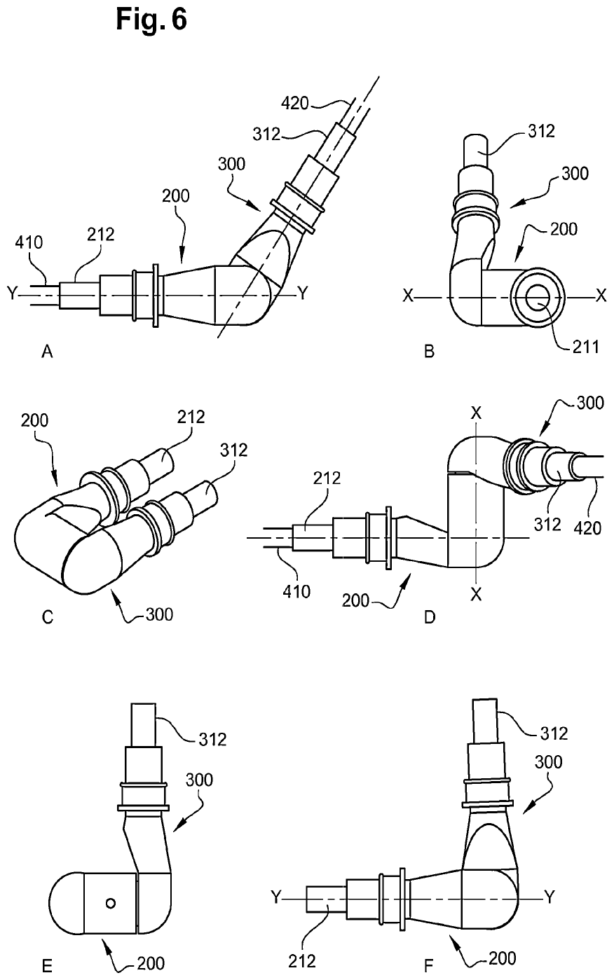

Once assembled, the two wiring heads 200 and 300 are rotatably movable relative to each other. In other words, when the two cable heads 200 and 300 are assembled, all rotary movements of the first cable head 200 relative to the second cable head 300—and vice versa—are permitted. The two cable heads 200, 300 can therefore be positioned relative to each other at a chosen angle which can vary between 0° and 360° about axis XX or axis YY. The two cable sections 410 and 420 can therefore be oriented at any angle between 0° and 360°. Examples of several relative positions of the first cable head 200 with respect to the second cable head 300 are represented in FIG. 6. Drawings A, B and D in FIG. 6 show an example of an angular deviation of approximately 120° between the first wiring head 200 and the second wiring head 300. Drawings E and F in FIG. 6 show different examples of an angular deviation of approximately 90° between the first wiring head 200 and the second wiring head 300. Drawing C in FIG. 6 shows an example of an angular deviation of 360° between the first wiring head 200 and the second wiring head 300. Of course, all intermediate angles can be achieved by rotating at least one of the two wiring heads 200, 300.

As represented in FIGS. 1, 3 and 4, the junction device 100 includes, according to some embodiments, a retaining clip 110, an O-ring seal 120, an electrical contact ring 130 and/or a shielding continuity ring 140. The retaining clip 110 may be, for example, a circlip mounted between the first conductive element 210 and the second conductive element 310 to prevent any relative translational displacement between the first and second conductive elements. This retention clip 110 may, for example, be partially housed in a first groove 215 on the external surface of the arm 211 of the first conductive element 210 and partially housed in a second groove on the internal surface of the arm 311 of the second conductive element 310. The retention clip 110, initially mounted to the arm 211 of the first conductive element 210, deforms upon introducing the arm 211 of the first conductive element 210 into the arm of the second conductive element 310 and then expands into the second groove in the arm 311 of the second conductive element 310. Once the retention clip 110 has expanded into the two grooves, the first and second conductive elements 210, 310 are mechanically integral with each other. No relative translational movement is then permitted. Only rotary movement about the XX axis is permitted. Once the retention clip 110 has been installed between the two cable heads 200 and 300, there is no further access to the retention clip. The two wiring heads 200 and 300 are then inseparable from each other. This inseparability of the wiring heads, combined with the crimping of the cable sections 410, 420 in said wiring heads 200, 300, results in electrical continuity between the first cable section 410 and the second cable section 420.

In one alternative, the translating assembly of the first and second wiring heads may be carried out by any other device, such as a mechanical screw/nut type assembly or crimping, for example.

The O-ring seal 120 is a seal for being housed between the second insulating element 320 and the first insulating element 220, in the clearance between the arm 211 of the first conductive element 210 and the arm 221 of the first insulating element 220 so as to ensure that the junction device 100 is sealed against air and moisture. Alternatively, the O-ring 120 may be replaced by a flat gasket, for example in the case of a disc-shaped planar pressure contact as previously mentioned.

The electrical contact ring 130, or power ring, is a ring of conductive material, endowed with some elasticity and dimensioned to ensure current conduction between the two wiring heads 200, 300. This power ring 130 may be, as represented in FIG. 2, a reed contact, a spring contact, a reed washer or any other flexible contact known in the electrical field to ensure electrical power conduction between two electrical components.

In some embodiments, the junction device 100 is equipped with an electromagnetic shielding for protecting the electrical conduction elements (cable, conductive elements, etc.) from possible electromagnetic disturbances and/or lightning, and/or to protect environment of the power cable (other wirings, equipment, antennae) from possible electromagnetic disturbances emitted by the same. This shielding comprises a metal braid (not represented in the figures) extending over the entire length of the cable. When the cable 400 is divided into two cable sections 410, 420, the metal braid is also divided into two braid portions each extending along the length of one of the cable sections 410, 420, above the insulating sheath of said cable sections. The shielding also comprises a metallisation (not visible in the figures) deposited onto the first and second insulating elements 220 and 320 to ensure electrical continuity between the two portions of metal braid. More precisely, the external surfaces of the insulating elements 220, 320 are partially metallised so that the metallised zone (also called metallisation) is continuous along the entire length of the junction device.

According to these exemplary embodiments, the insulating elements 220, 320 may each comprise a knurling zone, 223 and 323 respectively, for connecting the metal braids using, for example, a spring-loaded clamping band, a “Band-it” type clamp or any other known device for connecting a metal braid. The knurling zone 223, 323, formed in the forearm 222, 322 of each insulating element, may comprise one or more ridges, produced for example upon injecting the insulating material to overmould the first and second conductive elements 210, 310.

Advantageously, the shielding also comprises a shielding continuity ring 140, for example in the form of a reed contact, ensuring electrical continuity of the shielding between the first and second wiring heads 200, 300. Thus, the two metal braid portions are connected, at the place of the knurling zones 223, 323, by the metallised zone and, at the junction of the two wiring heads, by the shielding continuity ring 140 so that electrical continuity of the shielding is ensured.

According to other embodiments, an intermediate wiring head (not visible in the figures) is mounted between the first wiring head 200 and the second wiring head 300. This intermediate wiring head includes an intermediate, cylindrical shape, electrically conductive arm having the same cross-sectional area as the first arm 211 and/or the second arm 311. It also includes an intermediate insulating element, substantially identical to the insulating elements 220 and 320, possibly metallised to ensure electrical continuity of the electromagnetic shielding, and whose function is identical to that of the insulating elements 220 and 320. The intermediate wiring head also includes an intermediate retention clip designed to be mounted in a groove in the intermediate arm and in the groove in the first arm 211 and/or the second arm 311. It also includes an intermediate electrical contact ring, housed between the intermediate arm and the first arm 211 and/or the second arm 311. This intermediate wiring head is mounted between the first wiring head 200 along a first axis of rotation, for example axis XX, and the second wiring head 300 along a second axis of rotation, for example axis YY. In other words, the electrical junction device of these embodiments includes a first wiring head 200 and a second wiring head 300, as previously described, as well as an intermediate wiring head and all the other elements (e.g. retention clip, O-ring seal, electrical contact ring, shielding continuity ring and/or attachment screw) in duplicate. The presence of the intermediate wiring head gives the device a double rotation. Indeed, with this intermediate wiring head, the first wiring head is orientable in a first orientation (for example XX) with respect to the intermediate wiring head and the second wiring head is orientable in a second orientation (for example YY) with respect to said intermediate wiring head, the first wiring head 200 thus being orientable according to a double orientation (XX and YY) with respect to the second wiring head 300.

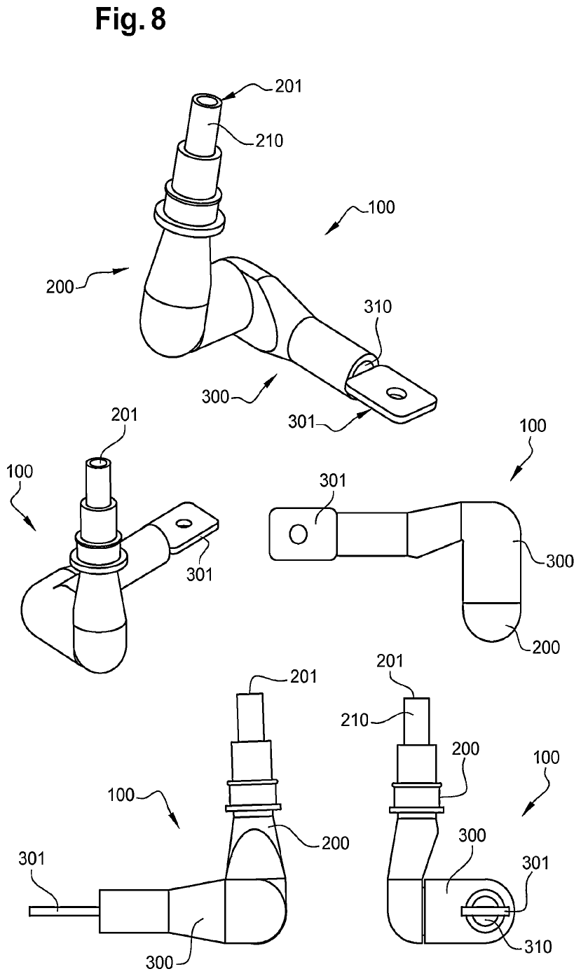

As defined previously, the term “cable” used in the description designates any type of conductive, single-stranded or multi-stranded, flat or round wire, surrounded by a dielectric material. The term “cable” therefore includes both cables with a round cross-section and those with a rectangular cross-section, such as buses, busbars, terminal blocks and other connection equipment. In embodiments where the cable is of a round cross-section, the connection zone for the conductive element 210, 310 is also of a round cross-section to ensure a proper electrical connection between the conductive element and the cable section. In embodiments where the cable is of rectangular cross-section, the connection zone of the conductive element 210, 310 is also of rectangular cross-section to ensure a proper electrical connection between the conductive element and the cable section. Of course, the cable sections 410, 420 to be connected may be of different types and have different cross-sections, cross-sections or shapes and/or dimensions; in such cases, the junction device 100 according to the invention includes different connection zones. In FIG. 8, several examples of a junction device 100 in which one of the connection zones is adapted to a cable with a round cross-section and the other connection zone is adapted to a cable with a rectangular cross-section, such as a busbar or a terminal block are represented. According to these examples, the junction device 100 includes a first wiring head 200 whose conductive element 210 is equipped with a hollow, round cross-section, connection zone 201 adapted to be connected through crimping around a round cross-section cable section, and a second wiring head 300 whose conductive element 310 is equipped with a flat, rectangular cross-section, connection zone 301, adapted to be connected through screwing to a terminal block or bus bar.

As can be understood from the above, the junction device according to the invention makes it possible, in all its embodiments, to reduce the overall size required to change direction of the cables and to eliminate mechanical forces in the curvature zones, which facilitates installation of the cables in a restricted space, reduces the risk of partial discharges occurring in the curvature zone of said cables (by eliminating mechanical stresses which can damage the insulators), increases the number of cables likely to run in a defined space and reduces forces on the supports for attaching the cables to the structure.

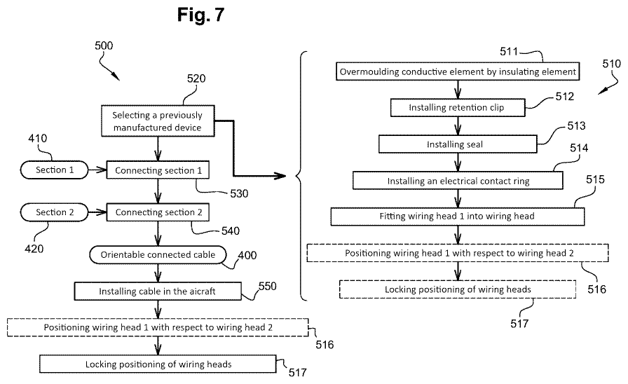

The first electrical cable section 410 is connected to the second electrical cable section 420 according to a connection method 500 functionally represented in FIG. 7. These cable sections may, for example, be sections of a copper or aluminium cable with a cross-sectional area of 107 mm² (AWG4/0) or a cross-sectional area of 85 mm² (AWG3/0).

This method 500 includes a first operation 520 of selecting the junction device best adapted to the desired curvature of the cable. Indeed, in a preferred embodiment, the junction device 100 is manufactured prior to being mounted between the two cable sections 410, 420. The junction device is therefore manufactured with forearms 212, 312 or connection zones with predefined shape and/or dimensions. It can also be manufactured with a predefined relative orientation between the wiring heads, the position of each of the wiring heads then being locked. According to a preferred embodiment, it can be manufactured with a non-definitive orientation, the position of the wiring heads then not being locked and being able, consequently, to be adjusted after connection with the cable sections and/or during installation of the cable 400 on the aircraft.

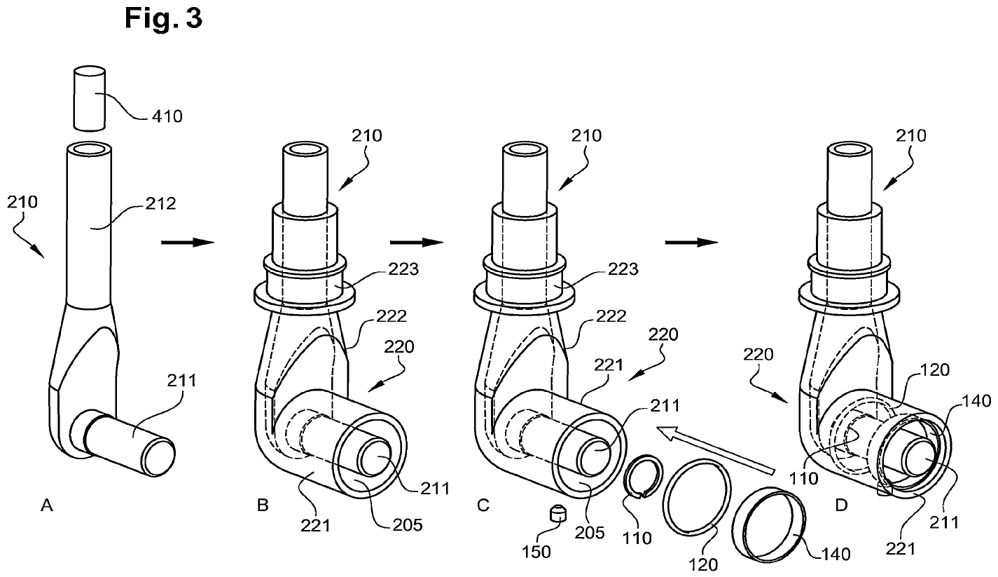

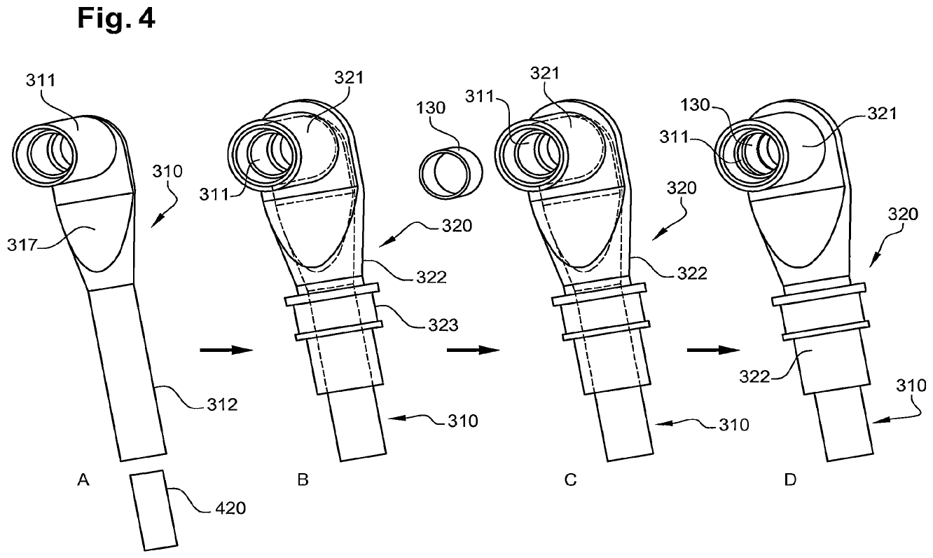

The method 500 then includes operations 530, 540 of connecting the two cable sections 410, 420 with the two conductive elements, 210, 310 respectively, of the first and second wiring heads 200, 300. More precisely, the first cable section 410 (or section 1) is connected (operation 530) with the first conductive element 210 of the first wiring head 200, as represented in drawing A of FIG. 3, and the second cable section 420 (or section 2) is connected (operation 540) with the second conductive element 310 of the second wiring head 300, as represented in drawing A of FIG. 4. These connection operations 530, 540 can be carried out, for example, by crimping. They may also be carried out by soldering, screwing or any other electrical connection technique known in the art.

Once the junction device 100 has been connected, on the one hand, to the first section 410 and, on the other hand, to the second section 420, the cable 400 is connected and oriented.

The cable 400 connected can then be installed in the aircraft (step 550). Once in place, an operation 516 of relatively positioning the two cable heads 200, 300 with respect to each other is carried out. During this operation, the orientation of the two wiring heads 200, 300 is modified manually, without tools, by simply rotating either or both of the wiring heads 200, 300. This rotation, represented by an arrow in part B of FIG. 5, is carried out until the desired angle is obtained between the wiring heads 200, 300. In the example in part B of FIG. 5, the second wiring head 300 is oriented at an angle of approximately 120° with respect to the first wiring head 200. An operation 517 of locking relative angular positioning between the two wiring heads 200, 300 is then performed, by means of a locking device. This locking device ensures locking of the relative angular positioning between the first and second cable heads, preventing any rotation between said first and second cable heads, once the first and second cable sections 410, 420 are in position. The locking device may, for example, be a locking screw 150 at least partially housed in the first and second insulating elements. Once this locking screw 150 is mounted, any relative rotation of the cable heads 200 and 300 is no longer permitted. The junction device 100 is then fixed and installed between the two cable sections 410, 420.

For the connection method 500 to be implemented, operations 510 of manufacturing the junction device 100 have been previously carried out. These manufacturing operations 510 include first of all an operation 511 of overmoulding the first conductive element 210 and the second conductive element 310. This overmoulding operation 511 consists in overmoulding the first and second conductive elements 210, 310 with, respectively, a first and a second insulating element 220, 320 so as to obtain, respectively, a first wiring head 200 and a second wiring head 300. In the case of the overmoulding of the first conductive element 210, a die can be mounted around the first conductive element during the overmoulding operation in order to generate a clearance 205 between the first conductive element and the first insulating element, after removal of the die. One example of the first conductive element 210 overmoulded with the first insulating element 220 is represented in drawing B of FIG. 3 and an example of the second conductive element 310 overmoulded with the second insulating element 320 is represented in drawing B of FIG. 4. Of course, as previously described, the insulating elements 220, 320 may be formed by techniques other than overmoulding.

The manufacturing operations 510 then include an operation 512 of installing the retention clip 110 around the first conductive element 210, as represented in drawing C of FIG. 3, followed by an operation 513 of installing the O-ring seal 120 between the first insulating element 220 and the second insulating element 320. In embodiments where the junction device includes a shielding continuity ring 140, the same is installed between the first insulating element 220 and the second insulating element 320, following installation of the retention clip 110 and the O-ring seal 120.

The manufacturing operations 510 then include an operation 514 of installing the electrical contact ring 130 between the arm of the first conductive element 210 and the arm of the second conductive element 310. This electrical contact ring 130 may also be installed immediately before or immediately after the operation 512 of installing the retention clip 110.

The person skilled in the art will comprise that the retention clip 110, the O-ring seal 120, the shielding continuity ring 140 and the electrical contact ring 130 may be mounted indifferently on either of the first/second conductive elements 210/310 and first/second insulating elements 220/320.

One example of the first wiring head 200 as obtained after the installation of the retention clip 110, the O-ring seal 120 and the shielding continuity ring 140 is represented in drawing D of FIG. 3. One example of the second wiring head 300 as obtained after the installation of the electrical contact ring 130 is represented in drawing D of FIG. 4.

The manufacturing operations 510 then include an operation 515 of fitting the first and second wiring heads 200, 300 into each other. As represented in FIG. 5, part A, the first and second wiring heads 200, 300 are fitted into each other along axis XX, the first conductive element 210 inserting into the second conductive element 310, the second conductive element 310 with the second insulating element 320 inserting into the clearance 205 between the first conductive element 210 and the first insulating element 220. For the fitting operation 515, the axis of rotation XX of the second wiring head 300 is aligned with the axis of rotation of pieces in the first wiring head 200.

According to one alternative, the operation 516 of relatively positioning the two wiring heads 200, 300 with respect to each other and the operation 517 of locking relative angular positioning between the two wiring heads 200 are implemented at the end of the manufacturing operations 510, rather than after the operation 550 of installing in the aircraft. Operations 516 and 517 are identical in this alternative (which is represented in dotted lines in FIG. 7) as in the alternative previously described.

According to another embodiment of the method 500, not represented in the figures, the two wiring heads 200, 300 are manufactured, as explained previously (operations 511 to 514), separately, without being fitted into each other. Each of the wiring heads 200, 300 is then connected, for example by crimping or soldering, to one of the cable sections 410, 420. Once connected to the cable sections, the two cable heads are assembled together (operation 515). Operations 516 and 517 are performed in the same way as in the embodiments previously described.

According to yet another exemplary embodiment of the method 500, not represented in the figures, each of the cable sections 410, 420 is connected, for example crimped or soldered, with the first conductive element 210 and the second conductive element 310 respectively. These first and second conductive elements 210, 310 are then overmoulded in accordance with previously described operation 511 to obtain wiring heads 200 and 300. Operations 512 to 514 of installing the retaining clip, the seal, the electrical contact ring, as well as operations 515 to 517 of fitting, positioning and locking the two wiring heads 200, 300 are then carried out, as previously described.

Those skilled in the art will understand that the two cable sections 410, 420 connected through the junction device 100 according to the invention may be identical or, on the contrary, different. The two cable sections may, for example, be of different cross-sectional areas and/or different materials, such as, for example, a copper cable section with a cross-sectional area of 68 mm² (AWG2/0) and an aluminium cable section with a cross-sectional area of 85 mm² (AWG3/0).

Although described for application in aeronautics, the electrical junction device as described above can find applications in all fields of electrical power transport, such as rail, maritime, land, space and industrial fields.

Although described through a number of examples, alternatives and embodiments, the electrical junction device according to the invention and the method for connecting two cable sections by means of this junction device comprise various alternatives, modifications and improvements which will be obvious to the person skilled in the art, it being understood that these alternatives, modifications and improvements are within the scope of the invention.

1. An electrical junction device for connecting a first section and a second section of an electrical power cable, comprising a first wiring head and a second wiring head orientable with respect to each other:
the first wiring head including:
a first L-shaped conductive element mounted at an end of the first cable section and including a cylindrical shape arm; and
a first insulating element surrounding the first conductive element;
the second wiring head including:
a second L-shaped conductive element mounted at an end of the second cable section and including a hollow cylindrical shape arm; and
a second insulating element covering the second conductive element, the arm of the second conductive element covered with the second insulating element being housed between the first conductive element and the first insulating element so as to permit rotation between the first wiring head and the second wiring head,
the electrical junction device further comprising a retention clip mounted between the first conductive element and the second conductive element to prohibit any translational displacement of the first wiring head relative to the second wiring head.

2. The electrical junction device according to claim 1, wherein an external surface of the arm of the first conductive element includes a first groove and an internal surface of the arm of the second conductive element includes a second groove, the retention clip being partly mounted in the first groove and partly in the second groove.

3. The electrical junction device according to claim 1, wherein the first conductive element and the second conductive element each comprise a hollow forearm, adapted to receive, respectively, the first cable section and the second cable section.

4. The electrical junction device according to claim 3, wherein the first section of the electrical cable and the second section of the electrical cable are mounted by crimping, respectively, in the first conductive element and in the second conductive element.

5. The electrical junction device according to claim 1, comprising an O-ring seal housed between the first insulating element and the second insulating element.

6. The electrical junction device according to claim 1, comprising an electrical contact ring housed between the arm of the first conductive element and the arm of the second conductive element.

7. The electrical junction device according to claim 1, wherein the first and second insulating elements each comprise, on their external surface, an electromagnetic shielding metallisation zone.

8. The electrical junction device according to claim 7, comprising a shielding continuity ring housed between the first insulating element and the second insulating element.

9. The electrical junction device according to claim 3, wherein the first insulating element and the second insulating element each comprise, on their forearm, a knurling zone adapted to receive an electromagnetic shielding braid.

10. The electrical junction device according to claim 1, comprising a locking device for ensuring locking of the relative angular positioning between the first and second wiring heads once the first and second cable sections are in position.

11. The electrical junction device according to claim 10, wherein the locking device includes a screw passing through the first insulating element and partially housed in the second insulating element.

12. The electrical junction device according to claim 1, wherein the second insulating element and/or the first insulating element is overmoulded, respectively, on the second conductive element and/or the first conductive element.

13. The electrical junction device according to claim 1, wherein the arm of the first wiring head and the arm of the second wiring head are positioned along a first axis of rotation, the first wiring head being orientable through up to 360° along this axis of rotation with respect to the second wiring head.

14. The electrical junction device according to claim 1, comprising an intermediate wiring head, said intermediate wiring head being mounted with the first wiring head along a first axis of rotation and mounted with the second wiring head along a second axis of rotation so that the first wiring head is orientable in two directions with respect to the second wiring head.

15. The electrical junction device according to claim 1, wherein the first conductive element and/or the second conductive element includes, at an end opposite to the arm, a planar connection zone for interfacing with flat equipment such as a busbar or a terminal block.

16. A power cable comprising at least a first cable section and a second cable section, wherein the first cable section and the second cable section are connected by means of an electrical junction device according to claim 1.

17. A method for connecting a first section of electrical cable to a second section of electrical cable by means of the electrical junction device according to claim 1, comprising:
selecting a previously manufactured junction device;
connecting the first cable section to the first L-shaped conductive element of the first wiring head; and
connecting the second cable section to the second L-shaped conductive element of the second wiring head.

18. The connection method according to claim 17, comprising:
an operation of installing the first and second cable sections connected;
relatively angularly positioning the first wiring head with respect to the second wiring head; and
mounting a locking screw at least partially in the first and second insulating elements in order to lock relative angular positioning of the first and second wiring heads.

19. The connection method according to claim 17, comprising prior manufacturing operations of the junction device:
overmoulding the first conductive element by a first insulating element so as to form the first wiring head;
overmoulding the second conductive element by a second insulating element so as to form the second wiring head;
installing a retention clip between an arm of a first conductive element and an arm of a second conductive element;
installing an O-ring seal between the first insulating element and the second insulating element;
installing an electrical contact ring between the arm of the first conductive element and the arm of the second conductive element;
fitting the first wiring head into the second wiring head.

20. The connection method according to claim 17, comprising at least one of the following operations:
making a metallisation zone on an external surface of the first and second insulating elements; and
installing a shielding continuity ring between the first insulating element and the second insulating element.
